(19) United States
(12) Patent Application Publication
(10) Pub. No.: US 2015/0213828 A1
(43) Pub. Date: Jul. 30, 2015

(54) OPTICAL DISK INSPECTION METHOD AND OPTICAL DISK LIBRARY DEVICE

(71) Applicant: Hitachi-LG Data Storage, Inc., Tokyo (JP)

(72) Inventors: Takakiyo YASUKAWA, Tokyo (JP); Shinji FUJITA, Tokyo (JP)

(73) Assignee: HITACHI-LG DATA STORAGE, INC., Tokyo (JP)

(21) Appl. No.: 14/594,500

(22) Filed: Jan. 12, 2015

(30) Foreign Application Priority Data
Jan. 29, 2014 (JP) 2014-013900

(51) Int. Cl. G11B 7/24097; G11B 17/22

(52) U.S. Cl. CPC G11B 7/24097; G11B 17/225

(57) ABSTRACT

An optical disk library device includes an optical disk storage unit that stores a plurality of optical disks, a plurality of record and reproduction units that record and reproduce data with respect to the optical disk, a. transporting mechanism that transports the optical disk between the optical disk storage unit and record and reproduction unit, a library control unit that controls the optical disk library device, and an interface that transmits data and commands to and receives data and commands from a higher device, in which the library control unit controls a record and reproduction unit so as to inspect a predetermined inspection area of an optical disk on which data is recorded based on data recording conditions, and stores an acquisition value obtained by the inspection.

### CROSS-REFERENCE TO RELATED APPLICATION

This application claims the Japanese Patent Application No. 2014-013900 filed Jan. 29, 2014, which is incorporated herein by reference in its entirety.

### BACKGROUND OF THE INVENTION

1. Field of the Invention

The present invention relates to an optical disk inspection method and an optical disk library device.

2. Background Art

The related art of the present invention is, for example, a technology disclosed in JP-A-2006-228302. JP-A-2006-228302 discloses “it is possible to easily create an optical disk for inspection and adjustment and select an optimal signal state as an inspection signal among signal recording areas in inspection and adjustment by selecting a signal state optimal for the inspection and recording address information, or the address information and information on a recording state of the signal recording area to an information recording area”.

JP-A-2006-228302 discloses that a signal recorded in an optical disk is selected from signals in an optimal signal state by preparing a plurality of signals in advance. However, there is no disclosure that a signal state of the optical disk on which data is previously recorded is inspected.

### SUMMARY OF THE INVENTION

The present invention has been made to efficiently inspect a signal state of the optical disk on which data is previously recorded.

In order to solve the above described problem, a configuration described in claims is used as an example in the present invention.

According to the present invention, it is possible to efficiently inspect the signal state of the optical disk.

### BRIEF DESCRIPTION OF THE DRAWINGS

FIG. 1 is a flowchart of inspection of an optical disk in a first embodiment.

FIG. 2 is a block diagram of an optical disk library device in the first embodiment.

FIG. 3 is a block diagram of an optical drive in the first embodiment.

FIG. 4 is a diagram illustrating a relationship between an inspection range in surface of a disk and an evaluation area.

FIG. 5 is a condition table for inspection of an optical disk stored in a memory.

FIG. 6 is a correlation diagram of a deviation between the number of averaged acquisition blocks and a quality inspection.

FIG. 7 is a condition table for inspection of an optical disk stored in a memory.

FIG. 8 is a flowchart of inspection of an optical disk in the first embodiment.

### DETAILED DESCRIPTION OF THE INVENTION

Hereinafter, an embodiment of an optical disk library device according to the present invention will be described with reference to the drawings.

### First Embodiment

As a first embodiment of the present invention, a configuration and an operation of the optical disk library device will be described in detail with reference to the drawings. Meanwhile, a Blu-ray Disc (trade mark) is used as an optical disk in the present embodiment, but not limited thereto. Any optical disk other than the Blu-ray Disc may be employed and other compatible media and a recording and reproduction device may be mounted.

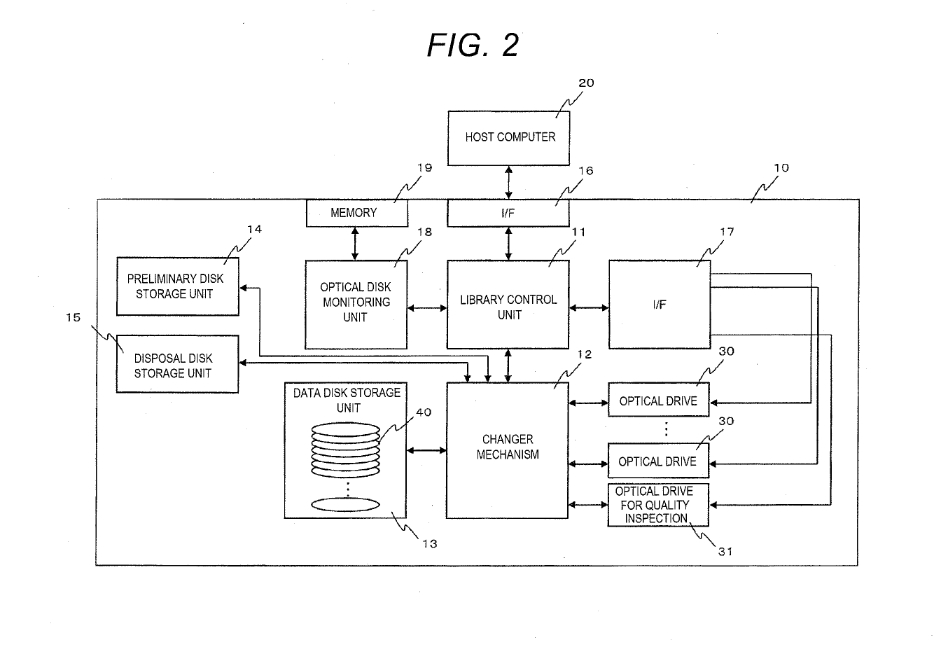

FIG. 2 is a block diagram of the optical disk library device of the first embodiment. An optical disk library device 10 of the present embodiment is configured to have a library control unit 11, a changer mechanism 12, a data disk storage unit 13 which stores a plurality of optical disks 40, a preliminary disk storage unit 14, a disposal disk storage unit 15, a host interface 16, a drive interface 17, an optical disk monitoring unit 18, a memory 19, a plurality of optical drives 30, and an optical drive for quality inspection 31. The changer mechanism 12 is a transporting mechanism which transports the optical disk between the data disk storage unit 13 and the optical drive 30.

The optical disk library device 10 is connected to a host computer 20 via the host interface 16, receives data to be recorded or a variety of commands such as recording and reproducing data, and then transmits an execution result of the commands and reproduced data.

The data disk storage unit 13 is provided with a plurality of slots and can store the optical disks 40. one by one in each slot.

The preliminary disk storage unit 14 is not used for a normal operation of the optical disk library device 10. However, when it is determined that the optical disk 40 exceeds a reference value through the inspection, the optical disk 40 is supplied from the preliminary disk storage unit 14 to the data disk storage unit 13.

The disposal disk storage unit 15 is a storage unit for the optical disk 40 which is determined to exceed the reference value in the disk inspection by the optical disk library device 10.

The library control unit 11 has a function of controlling overall operations of the optical disk library device 10. When performing data access to the optical disk 40 which is stored in the data disk storage unit 13, that is, at the time of reproducing the data stored in the optical disk 40, or when writing data to the optical disk 40, the library control unit 11 operates the changer mechanism 12 to extract the predetermined optical disk 40 from the data disk storage unit 13 so that the extracted optical disk 40 is transported to the optical drive 30, which performs the data access, so as to be loaded. In addition, the library control unit 11 is connected to each optical drive 30 via the drive interface 17 and receives a variety of commands such as recording and reproduction for the predetermined optical drive 30.

The optical disk monitoring unit 18 manages a state of the optical disk 40, and the memory 19 holds information of data management stored in the optical disk 40, recording quality of the optical disk 40, an inspection period of the optical disk 40 and the like which are detected by the optical disk monitoring unit 18.

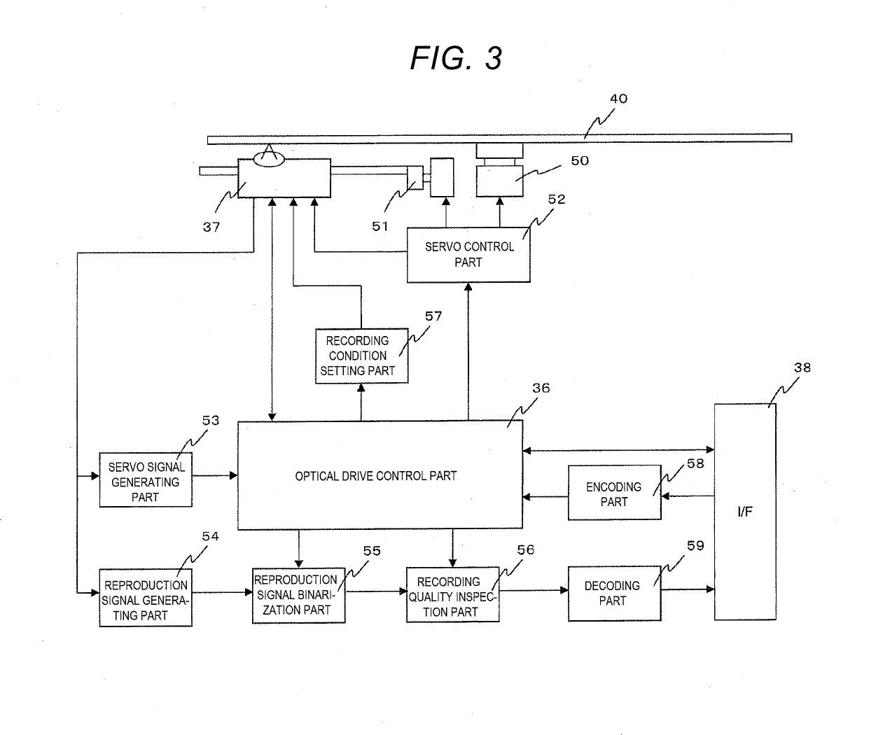

FIG. 3 is a block diagram of the optical drive 30 in the first embodiment. The optical drive 30 of the embodiment is configured to have an optical drive control part 36, an optical pickup 37, a controller interface 38, a disk rotation mechanism 50, a slider mechanism 51, a servo control part 52, a servo signal generating part 53, a reproduction signal generating part 54, a reproduction signal binarization part 55, a recording quality inspection part 56, a recording condition setting part 57, an encoding part 58, and a decoding part 59.

The optical drive control part 36 controls overall operations of the optical drive 30. That is, the optical drive control part 36 performs rotation control of the optical disk 40 which is mounted on the disk rotation mechanism 50 via the servo control part 52, performs seek control and sending control such that the optical pickup 37 is displaced in the radial direction of the optical disk 40 by driving the slider mechanism 51, and then performs focus control and tracking control by driving an object lens of the optical pickup 37.

In addition, the optical drive control part 36 controls laser emission performed by the optical pickup 37. At the time of recording, a recording data signal, which is transmitted from the library control unit 11 via the controller interface 38, is converted into an NRZI signal in the encoding part 58 based on a predetermined demodulation rule and then supplied to the optical drive control part 36. The optical drive control part 36 supplies the NRZI signal to the recording condition setting part 57. The recording condition setting part 57 converts a recording strategy into a recording strategy (emitted light pulse string) corresponding to the NRZI signal so as to emit laser beams with a predetermined light intensity and pulse strings.

A light amount reflected from the optical disk 40 is received by a photoelectric detector of the optical pickup 37 and converted into an electrical signal so as to be transmitted to the servo signal generating part 53 and the reproduction signal generating part 54. The servo signal generating part 53 selects and generates various types of servo signals by means of an inspection method which is preferable for the mounted optical disk 40, and then supplies the servo signals to the optical drive control part 36. The servo signals include at least a focus error signal and a tracking error signal. As described above, the optical drive control part 36 drives an object lens via the servo control part 52 so as to operate a focus servo and a tracking servo on the basis of the aforementioned servo signals.

The reproduction signal generating part 54 is provided with a waveform equalization circuit and an A/D converter, in which an analog reproduction signal supplied from the optical pickup 37 is converted into a digital signal by being subjected to a predetermined waveform equalization and then to sampling and quantizing so as to be supplied to the reproduction signal binarization part 55.

The reproduction signal binarization part 55 is provided with a transversal filter and a Viterbi decoding circuit. The digital signal supplied from the reproduction signal generating part 54 is equalized to a predetermined PR class through the transversal filter and subjected to a maximum likelihood decoding through the Viterbi decoding circuit, and thereafter, the equalized waveform is converted into an NRZI signal based on the predetermined demodulation rule. The NRZI signal generated from the reproduction signal binarization part 55 is converted into a reproduction data signal by performing data demodulation by the decoding part 59 and then transmitted to the library control unit 11 via the controller interface 38.

The recording quality inspection part 56 can inspect the reproduction error rate based on a jitter, which is a fluctuation component of a temporal axis of a binary signal serving as an inspection index of the recording quality, and the number of correction codes at the time of decoding by performing a data correction or the like.

The recording condition setting part 57 converts a recording strategy into a recording strategy (emitted light pulse string) corresponding to the encoded NRZI signal so as to emit laser beams with the predetermined light intensity and pulse strings.

The optical disk monitoring unit 18 regularly performs inspection of the quality of the optical disk 40, generates disk management information and inspection history information, and then stores the respective pieces of information into the memory 19. The optical disk monitoring unit 18 regularly performs the inspection of the quality of all of the optical disks 40 on which data is recorded stored in the data disk storage unit 13 and rewrites the data recorded on the corresponding optical disks with respect to the optical disks 40 stored in the preliminary disk storage unit 14 in a case where a value of the inspection result exceeds an inspection threshold. Hereinafter, description of this operation will be made in detail.

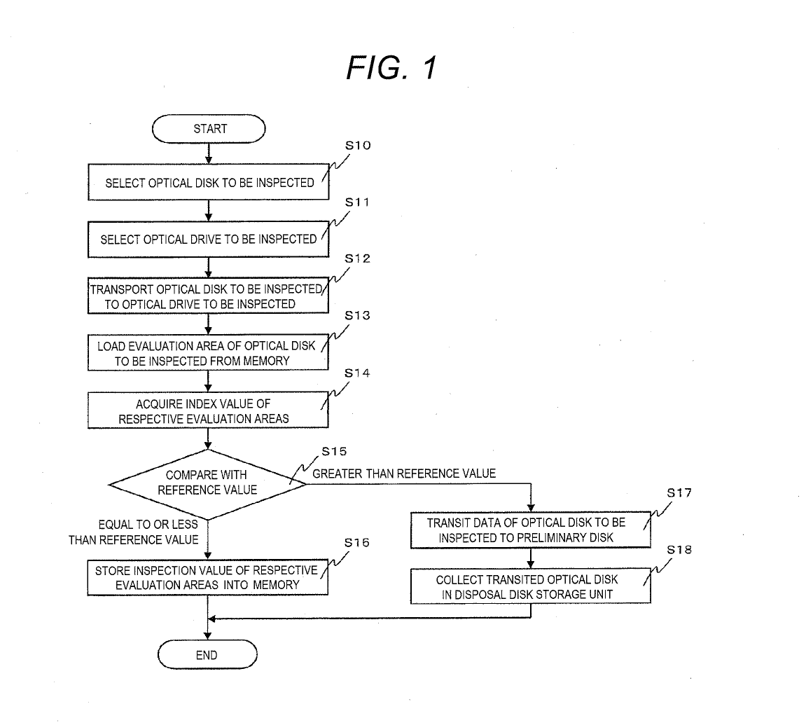

FIG. 1 is a flowchart in which the optical disk monitoring unit 18 inspects the optical disk 40 in the first embodiment. First, the optical disk 40 is selected to be inspected (S10). With regard to a selecting method, since it is needed to perform the inspection on all the optical disks on which data is recorded, an evaluation proceeds in order of the arrangement thereof. Here, when the optical disks are being read, mismatches in orders may occur, and therefore, it is necessary to flexibly respond, for example, by skipping the optical disk being accessed. Alternatively, the record orders may be employed without depending on the arrangement of the optical disks, and as long as the order for the inspection of all of the optical disks without omission is determined, there is no problem in terms of an operation. Next, an optical drive is selected to be a device for inspection (S11). A plurality of optical drives is mounted on one optical disk library device 10. In a case where the plurality of optical drives are mounted on the one optical disk library device 10, it is possible to stably inspect the quality of the optical disk by mounting the optical drive for quality inspection 31 in addition to the optical drive 30 which is used for a normal operation. There is at least one optical drive for quality inspection 31. Note that regarding the reproduction performance, it is possible to perform the operation with the optical drive 30 which is used in normal operation as long as the quality thereof is sufficiently stable. Next, the optical disk 40 selected in S10 is transported to the optical drive 31 selected in S11 (S12). Then, the optical disk monitoring unit 18 loads information on the evaluation area of the inspection target optical disk stored in the memory 19 (S13). Meanwhile, the description of information of the optical disk stored in the memory 19 will be made later. The optical disk monitoring unit 18 acquires an index value by performing reproduction inspection for the predetermined area of the optical disk based on the information stored in the memory (S14). Meanwhile, this index value is acquired by the recording quality inspection part 56 of the optical drive 30, and the number of ECC block errors, the error rate, or the jitter calculated by a. fluctuation component of a temporal axis of a reproduction signal is used as the index value. The comparison with the reference value is performed in step S15, and in a case where the result is equal to or less than the reference value and the recording quality is preferable, an inspection value of each of the evaluation areas is stored in the memory (S16), thereby completing an inspection flow. In step S15, if it is determined that the result is greater than the reference value and the quality is not preferable, since there is a problem in continuously holding data in the optical disk, the data stored in the inspected optical disk rapidly migrates to a preliminary disk (S17). Thereafter, after all items of data migrate from the optical disk to the preliminary disk, the optical disk overlaps on the operation and thus is collected in the disposal disk storage unit (S18).

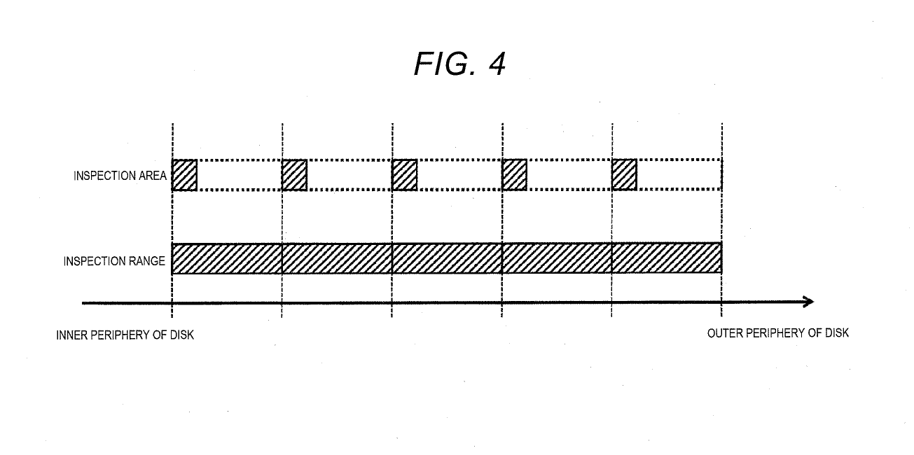

FIG. 4 is a diagram illustrating a relationship between an inspection range in a disk surface and an evaluation area. The optical disk which is mounted on the optical disk library device 10 is assumed to have a plurality of recording layers as a high capacity disk. Generally, main factors affecting life (reliability) of a disk are a recording layer, laminated materials in the vicinity of the recording layer, a structure thereof, and a storage environment. The storage environment means the environment where the optical disk is stored, and the quality degradation of the optical disk is differently affected according to a temperature and humidity. This tendency appears through the entire range and can be expected to some extent from a partial evaluation result of the optical disk. On the other hand, the recording state of the optical disk depends on individual differences and adjustment results of the drives, and it cannot be said that the same tendency can be expected among the recording layers. For this reason, a recording layer unit is assumed to have one inspection range. In this range, for example, a head part of each inspection range is assumed to be an actual inspection target (inspection area) which is acquired as the representative value. In addition, as for the inspection, since the stability of the accuracy thereof is required, the evaluation is performed based on a plurality of acquisition results obtained on the basis of an ECC (Error Correction Code) block serving as a unit of data demodulation. Therefore, it is possible to narrow the acquisition fluctuation and perform the stable quality inspection. In FIG. 4, the head part of each of the inspection ranges is defined as an evaluation area (inspection area) and the representative value of each of the inspection ranges is evaluated to be limited to the evaluation area in the inspection ranges, thereby reducing an inspection time without degradation of the inspection accuracy. Note that for the sake of convenience of description, the inspection range and the evaluation area are set to have the same size in FIG. 4, but may have different sizes from each other.

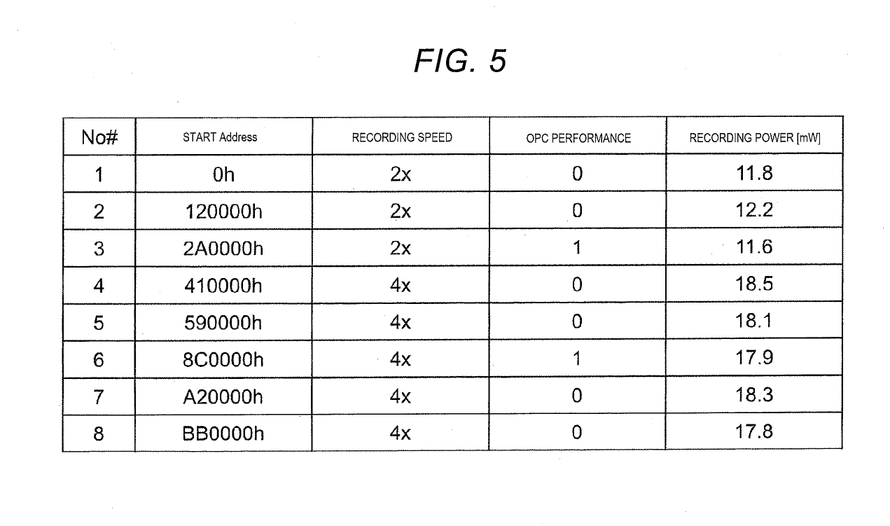

FIG. 5 is an example of a condition table for inspection of the optical disk stored in the memory. For the sake of convenience of description, the result of only one layer of the plurality of the optical disk layers is illustrated. It is possible to perform the confirmation of conditions under which the recording is performed in each inspection range in the optical disk. For example, by dividing the inspection ranges into two parts with the address 410000h as a standard, it is realized that Nos. 1 to 3 belong to one inspection range and No. 4 (410000h) onward belongs to the other inspection range since the recording is performed under the two conditions of recording speeds which are 2×-speed and 4×-speed. Thus, it is possible to improve the inspection accuracy of the recording quality by providing two inspection ranges in the optical disk based on the recording conditions. In order to further improve the inspection accuracy, the accuracy of quality acquisition in each area can be improved by dividing the inspection areas more finely based on the recording conditions. For example, when dividing is performed based on the recording power, the inspection range is more finely divided into eight parts compared to a case when dividing is performed based on the previous two types of recording speeds. Each of the inspection ranges has different recording powers from each other and thus it is possible to expect a result that the inspection range is differently degraded overtime. For this reason, it is possible to efficiently inspect the quality of the entirety of the disk by providing the evaluation area which is limited to each area as shown in FIG. 4 in these eight areas. The present table is acquired as the recording conditions of the optical drive at the time of recording on the corresponding optical disk.

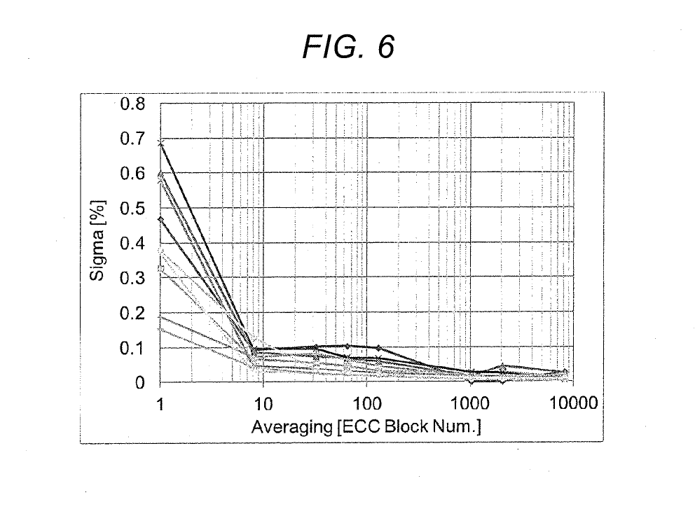

FIG. 6 illustrates a result of a deviation between the number of averaged acquisition blocks and the quality inspection. The result is obtained by performing the quality inspection in a plurality of areas in the plurality of optical disks. The result shows that the fluctuation is large when the data is acquired once and the numerical values are not reliable. In contrast, the deviation becomes smaller as the averaged number of times is increased, which results in the stable quality inspection being realized. In other words, it is possible to acquire an appropriate result by optimizing the number of acquired and averaged blocks in accordance with the inspection accuracy required for the optical disk library device. The modulation block of the Blu-ray Disc is 64 kByte, and it is necessary to average the value at least twice or more, that is, 128 kByte or greater in order to obtain the effect thereof.

Immediately after recording data in the optical disk, the same quality inspection as that of the above description is performed first so as to verify whether or not the appropriate recording quality can be secured. For example, in a case where a specification requires to realize the detection accuracy of α<0.1%, it is necessary to average at least 100 blocks. Further, in a case where the detection accuracy of the quality inspection satisfies α<0.05%, it is necessary to average more than 1000 blocks.

Next, a method of designating the evaluation area will be described. Since the evaluation area is an area which is representative of the inspection range, it is necessary to extract a characteristic area. For example, when the inspection range is about two times the evaluation area, the inspection range may be designated as the evaluation area simply from the head part thereof, or the latter half of the inspection range except for the head part may be designated as the evaluation area. In this case, the sufficient inclusive relationship is established and thus it is possible to perform the inspection with high accuracy.

On the other hand, in a case where the inspection range is greater than two times the evaluation area, there is concern that in-plane fluctuation in the disk is not completely removed. For this reason, the quality change may be detected by the result of the inspection performed in advance, for example, based on the inspection at the time of recoding, and the evaluation area having high sensitivity may be designated from the areas having the quality change detection completed.

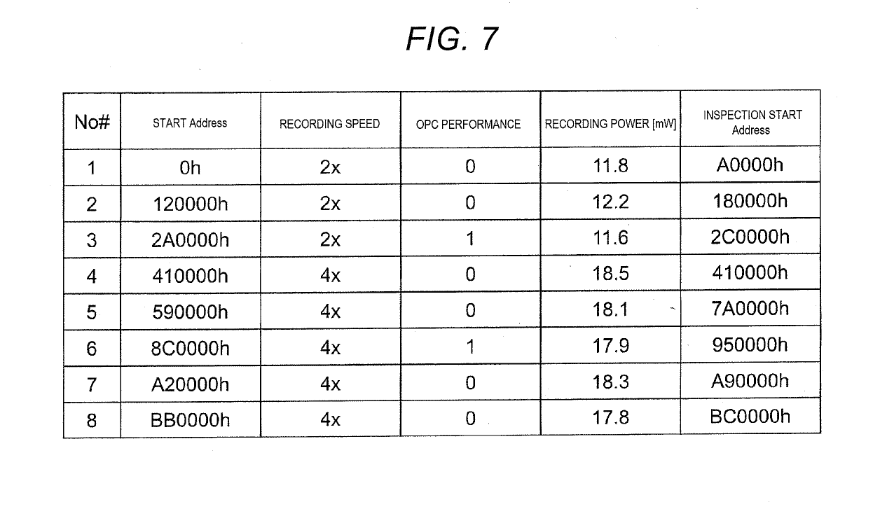

FIG. 7 shows an example of a condition table for inspection of the optical disk stored in the memory. This condition table is obtained by adding an inspection start address to the condition table in FIG. 5. For example, as a result of performing the inspection in each of the inspection ranges, an address of the head which becomes the evaluation value having the worst quality in the inspection ranges is stored in the memory. With this result, the inspection length is assumed to be 1000 blocks in terms of the required accuracy. In NO# for each of the inspection ranges, the inspection start address, the inspection length and the like are stored in the memory. The evaluation value having the worst quality in the inspection ranges is determined to be an area which causes a problem earliest in reproduction and thus becomes an effective evaluation value. On the other hand, the management with the evaluation value having the best quality is also an effective method. In general quality evaluation, when the evaluation value has a preferable quality, it is possible to detect noise factors (factors of the quality degradation) with high sensitivity.

When the aforementioned disk quality is confirmed, the inspection is performed within the limited evaluation area based on the information stored in the memory.

In the present embodiment, if the inspection range is assumed to be 100000h and the evaluation area (inspection area) is assumed to be 1000h, the entirety of the inspection time is likely to be reduced to satisfy 1000h/100000h=0.4%, and thereby the quality inspection can be efficiently realized. In addition, since the evaluation area is extracted from the inspection ranges which are in the same recording state, the result can be the representative value of the quality of all of the inspection ranges.

### Second Embodiment

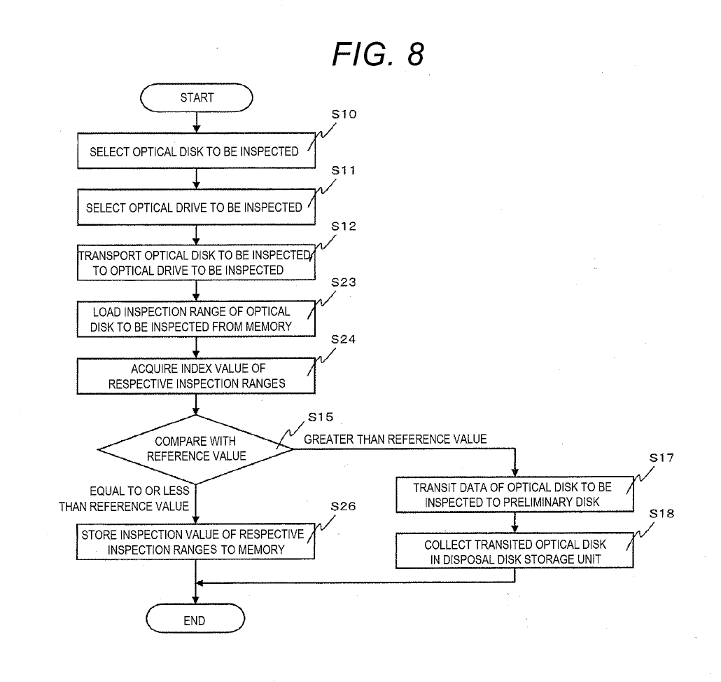

FIG. 8 is a flowchart of the quality inspection of the entire surface of an optical disk in an optical disk library system in a second embodiment of the present invention. A basic flow is similar to that of the first embodiment. After the optical disk of an inspection target is transported to the optical drive for quality inspection in S12, the optical disk monitoring unit 18 loads the inspection range which is the information of area divisions at the time of various types of recording of the inspection target optical disk from the memory 19 (S23). In the first embodiment, the evaluation area which is actually inspected is set to be limited from the inspection ranges. In the second embodiment, all of the inspection ranges, that is, all of the optical disks, are inspected to perform the quality inspection on the entire surface of the optical disk. Regarding an index value, the evaluation area where the inspection length is limited for each inspection range is regulated to associate with the inspection range, the evaluation area, and the index value. Accordingly, the result as the inspection value in each of the inspection ranges is stored in the memory. The inspection for entire surface of the optical disk depends on the number of optical disks which are mounted on the optical disk library system and the number of optical drives for quality inspection which perform the inspection and are mounted on the optical disk library system. In a case where one out of ten optical drives which are mounted on the optical disk library system is an optical drive for quality inspection which is assumed to store 500 optical disks, when 500 optical disks are inspected by one optical drive for the quality inspection, the expression of 93×500/60/24=32 is established and it takes approximately 32 days under the assumption that the entire surface is subjected to quality inspection at 4×-speed (it takes about 93 minutes for inspection of the entire surface of a disk). In consideration of a working rate of the optical disk library system and the inspection efficiency, when 1.0% of the inspection efficiency is realized, the expression of 32×0.01/24=8 is established and thereby it is possible to perform the quality inspection of all of the optical disks in about eight hours. Further, in a case where ten optical drives for quality inspection, which secure the reproduction quality, are mounted on the optical disk library system, it takes about three days for the quality inspection of all of the disks. It is possible to reduce the inspection time to within an hour by adapting the inspection efficiency which is assumed to be 0.1%.

It should be noted that the present invention is not limited to the embodiments described above, but includes various modifications. For example, the above embodiments are described in detail for easy understanding of the present invention, but it is not necessary to includes all of the configurations as described above. In addition, it is possible to replace a part of a configuration of one embodiment with a configuration of the other embodiment, and it is also possible to add the configuration of the other embodiment to the configuration of one embodiment. In addition, for some configurations of each embodiment, it is possible to add, delete, and replace them with other configurations.

Further, apart of or all of the respective configurations, functions, process units, processing means and the like described above, may be realized as hardware designed by an integrated circuit or the like. In addition, the respective configurations, functions and the like may be realized with software by a processor interpreting and performing a program to realize various functions. Information such as programs, tables, files, and the like which realize the respective functions can be placed on a recording device such as a memory, a hard disk, an SSD (Solid State Drive), or the like, or a recording medium such as an IC card, an SD card, a DVD, or the like.

In addition, a control line or an information line which are considered to be necessary in description are indicated, and therefore, all of the control lines and the information lines are not necessarily indicated on products. In fact, almost all of the configurations may be considered to be connected to each other.

What is claimed is:

1. An optical disk inspection method comprising:
inspecting a predetermined inspection area of an optical disk on which data is recorded based on data recording conditions; and
storing an acquisition value obtained by the inspection.

2. The optical disk inspection method according to claim 1, further comprising:
setting a plurality of inspection ranges based on data recording conditions with respect to the optical disk on which data is recorded; and
inspecting a predetermined inspection area of the respective inspection ranges.

3. The optical disk inspection method according to claim 2, further comprising:
setting an area on which data is recorded under the same condition as the inspection range.

4. The optical disk inspection method according to claim 3, further comprising:
comparing the stored acquisition value with a reference value.

5. The optical disk inspection method according to claim 3,
wherein, when the optical disk has a plurality of information layers, the area on which data is recorded under the same condition is an area on which data is recorded under the same condition in respective information layers.

6. The optical disk inspection method according to claim 3,
wherein the area on which data is recorded under the same condition is an area on which data is recorded under the same condition in a recording speed in control of the optical drive at the time of recording.

7. The optical disk inspection method according to claim 3,
wherein the area on which data is recorded under the same condition is an area on which data is recorded under the same condition in recording power in control of the optical drive at the time of recording.

8. The optical disk inspection method according to claim 1,
wherein a user data size of the inspection area is at least 128 kByte or higher.

9. The optical disk inspection method according to claim 2,
wherein the inspection area is an area in which a worst inspection value is detected from the inspection values acquired in the inspection range where the entire area of the inspection range is inspected before the inspection.

10. The optical disk inspection method according to claim 2,
wherein the inspection area is an area in which a best inspection value is detected from the inspection values acquired in the inspection range where the entire area of the inspection range is inspected before the inspection.

11. The optical disk inspection method according to claim 2,
wherein the inspection area is an area which is disposed in a head of the inspection range where the entire area of the inspection range is inspected before the inspection.

12. The optical disk inspection method according to claim 2,
wherein the inspection area is an area which is disposed in a center of the inspection range where the entire area of the inspection range is inspected before the inspection.

13. The optical disk inspection method according to claim 2,
wherein the inspection area is an area which is disposed at an end of the inspection range where the entire area of the inspection range is inspected before the inspection.

14. The optical disk inspection method according to claim 2,
wherein the inspection area is an area which is disposed in the innermost periphery of the inspection range where the entire area of the inspection range is inspected before the inspection.

15. The optical disk inspection method according to claim 2,
wherein the inspection area is an area which is disposed in the outermost periphery of the inspection range where the entire area of the inspection range is inspected before the inspection.

16. An optical disk library device, comprising:
an optical disk storage unit that stores a plurality of optical disks;
a plurality of record and reproduction units that record and reproduce data with respect to the optical disk;
a transporting mechanism that transports the optical disk between the optical disk storage unit, and the record and reproduction unit;
a library control unit that controls the optical disk library device; and
an interface that transmits data and commands to and receives data and commands from a higher device,
wherein the library control unit controls a record and reproduction unit so as to inspect a predetermined inspection area of an optical disk on which data is recorded based on data recording conditions, and stores an acquisition value obtained by the inspection.

17. The optical disk library device according to claim 16,
wherein the library control unit sets a plurality of inspection ranges with respect to the optical disk on which data is recorded based on data recording conditions and controls the record and reproduction unit so as to inspect a predetermined inspection area of the respective inspection ranges.

18. The optical disk library device according to claim 17,
wherein the library control unit sets an area on which data is recorded under the same condition as the inspection range.

19. The optical disk library device according to claim 18,
wherein the library control unit compares the stored acquisition value with a reference value.
